(19) United States
(12) Patent Application Publication
(10) Pub. No.: US 2011/0203977 A1
(43) Pub. Date: Aug. 25, 2011

(54) FILTRATION APPARATUS AND WATER TREATMENT APPARATUS

(75) Inventors: Keijirou Tada, Tokyo (JP); Hiroyuki Ikeda, Tokyo (JP); Masanobu Osawa, Tokyo (JP)

(73) Assignee: KURITA WATER INDUSTRIES LTD., Tokyo (JP)

(21) Appl. No.: 13/127,166

(22) PCT Filed: Oct. 30, 2009
(86) PCT No.: PCT/JP2009/068659

§ 371 Date: May 2, 2011

(30) Foreign Application Priority Data
Nov. 4, 2008 (JP) 2008-283579

(51) Int. Cl. C02F 9/02; B01D 29/00; C02F 1/52

(52) U.S. Cl. 210/96.1; 210/483; 210/198.1; 210/202

(57) ABSTRACT

The filtration apparatus of the invention includes a filtration member 12 which has a ribbon-like suspended-solid-capturing member for capturing suspended solid present in fed treatment water 1, wherein the filtration member is charged in a filtration tank 11 such that a filtration portion of the filtration tank has a percent void of 50 to 95% during passage of the treatment water.

### TECHNICAL FIELD

The present invention relates to a filtration apparatus which is suitably employed for the treatment of water such as industrial water, city water, well water, river water, lake water, or industrial wastewater after flocculation treatment, and to a water treatment apparatus employing the filtration apparatus.

### BACKGROUND ART

In one conventional method for treating water such as industrial water, city water, well water, river water, lake water, or industrial wastewater, an inorganic flocculant and a polymer (e.g., anionic polymer) flocculant are added to the water to be treated, to thereby adsorb or coagulate suspended solid particles (hereinafter referred to simply as “suspended solid”) contained in the water to be treated (i.e., flocculation treatment), and the adsorbed or coagulated solid is removed through sand filtration or dissolved-air flotation. However, a large-scale apparatus is required for performing sand filtration or dissolved-air flotation, which is problematic. In addition, when the water to be treated has high turbidity, suspended solid may fail to be removed sufficiently.

As one solution for such problems, Patent Document 1 discloses a filtration apparatus having a specific configuration. Specifically, the filtration apparatus includes a suspended-solid-removing apparatus on the upstream side of an ultra-filtration (UF) membrane module or a micro-filtration (MF) membrane module. In the suspended-solid-removing apparatus (A), raw water is fed as an up-to-down flow, and a washing liquid is fed as a down-to-up flow. A raw water-feed pipe and a washing liquid-discharge pipe each equipped with a valve are disposed at the top of a column (1), while a treated water-discharge pipe, a washing liquid-feed pipe and an air feed pipe each equipped with a valve are disposed at the bottom of the column (1). In the column, an upper support (2) and a lower support (3) are disposed, and a plurality of filtration members (4) are disposed between the upper support (2) and the lower support (3). Each filtration member (4) is formed of a core cord and a suspended-solid-capturing member protruding outward from the periphery of the core cord, and is fixed at ends thereof by an upper hanging cord (7) and a lower hanging cord (8), while maintaining a suspended state. The core cord of each filtration member (4), the upper hanging cord (7), and the lower hanging cord (8) are disposed such that these elements allow bending along the water flow direction. The distance (LA) between the upper support (2) and the lower support (3), the length (LB) of each filtration member (4), the length (Lb1) of the upper hanging cord (7), and the length (Lb2) of the lower hanging cord (8) satisfy specific formulas (1) to (3). However, according to the disclosed technique, when the water to be treated has high turbidity, the filtration apparatus suffers clogging, making high-speed water treatment difficult, which is problematic.

Another type of filtration apparatus is disclosed, the apparatus being employed in an apparatus for performing water replenishment of an electric power plant and employing a long fiber bundle (see Patent Document 2). This filtration apparatus also suffers clogging, and the water treated by the apparatus has impaired quality, which are problematic.

### PRIOR ART DOCUMENT

### Patent Document

### Patent Document 1:

Japanese Patent Application Laid-Open (kokai) No. 2003-24715

### Patent Document 2:

Japanese Patent Application Laid-Open (kokai) No. Hei 6-134490

### SUMMARY OF THE INVENTION

### Problems to be Solved by the Invention

In view of foregoing, an object of the present invention is to provide a filtration apparatus which can provide clear treated water and which is prevented from clogging. Another object is to provide a water treatment apparatus employing the filtration apparatus.

### Problems to be Solved by the Invention

In order to attain the aforementioned objects, the present inventors have conducted extensive studies, and have found that the objects can be attained by a filtration apparatus employing a filtration member which includes a ribbon-like suspended-solid-capturing member for capturing suspended solid present in fed water to be treated, wherein the filtration member is charged in a filtration tank such that a filtration portion of the filtration tank has a percent void of 50 to 95% during passage of the water. The present invention has been accomplished on the basis of this finding. The water to be treated by the filtration apparatus of the invention may be referred to as “treatment water.”

Accordingly, the present invention provides a filtration apparatus, characterized by comprising a filtration member which has a ribbon-like suspended-solid-capturing member for capturing suspended solid present in fed treatment water, wherein the filtration member is charged in a filtration tank such that a filtration portion of the filtration tank has a percent void of 50 to 95% during passage of the treatment water.

Preferably, the filtration member has a support member which is connected to both ends of the filtration tank along the water flow direction, and the ribbon-like suspended-solid-capturing member is provided such that the member is fixed at a part thereof to the support member and protrudes from the support member toward the inner wall of the filtration tank. Also preferably, the ribbon-like suspended-solid-capturing member is provided with one or more slits.

In another mode of the present invention, there is provided a water treatment apparatus characterized by comprising:

a reaction tank to which treatment water is introduced;

flocculant-introduction means for adding a flocculant to the treatment water at the reaction tank or on the upstream side of the reaction tank; and

the aforementioned filtration apparatus to which the treatment water which has been subjected to flocculation treatment in the reaction tank is introduced, the filtration apparatus being disposed on the downstream side of the reaction tank.

Preferably, the water treatment apparatus includes membrane separation means for treatment water disposed on the downstream side of the filtration apparatus.

Preferably, the flocculant is at least one species selected from an inorganic flocculant and a particulate cationic polymer which swells in water but does not substantially dissolve therein.

The water treatment apparatus may further include absorbance-measuring means for measuring the absorbance of treatment water, the means being disposed on the upstream side of the flocculant-introduction means, and first flocculant amount control means for controlling the amount of the flocculant added to treatment water on the basis of the absorbance measured by means of the absorbance-measuring means. In this case, the absorbance is preferably measured at at least one wavelength falling within a UV region of 200 to 400 nm and at at least one wavelength falling within a visible-light region of 500 to 700 nm.

The water treatment apparatus may further include turbidity-measuring means for measuring the turbidity of treatment water, the means being disposed on the upstream side of the flocculant-introduction means, and second flocculant amount control means for controlling the amount of the flocculant added to treatment water on the basis of the turbidity measured by means of the turbidity-measuring means.

Preferably, the water treatment apparatus further includes washing liquid introduction means for introducing a washing liquid and air into the filtration apparatus at an arbitrary frequency.

### Effects of the Invention

The filtration apparatus of the invention employs a filtration member which includes a ribbon-like suspended-solid-capturing member for capturing suspended solid present in fed treatment water, wherein the filtration member is charged in a filtration tank such that a filtration portion of the filtration tank has a percent void of 50 to 95% during passage of the treatment water. Therefore, suspended solid is effectively removed from treatment water, and clogging of the filtration apparatus is suppressed. The filtration apparatus may be connected to flocculation treatment means disposed on the upstream thereof, to thereby form a water treatment apparatus. Through provision of membrane separation apparatus on the downstream side of the filtration apparatus, the water treatment apparatus can provide clear treated water, and clogging of the membrane separation apparatus is suppressed. Hitherto, in the case of high-speed water treatment, or treatment of water having high turbidity, clear treated water is difficult to obtain, and clogging occurs in the filtration apparatus and the membrane separation apparatus, readily reducing water treatment performance, which is problematic. In contrast, by means of the filtration apparatus of the present invention, even in the case of high-speed water treatment, or treatment of water having high turbidity, clear treated water can be obtained, and clogging of the filtration apparatus and the membrane separation apparatus can be suppressed, attaining good water treatment performance.

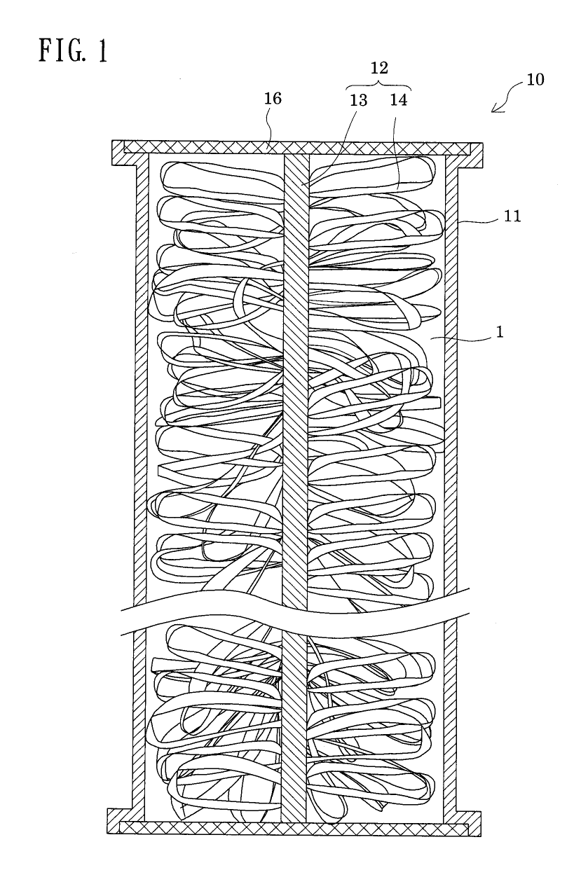

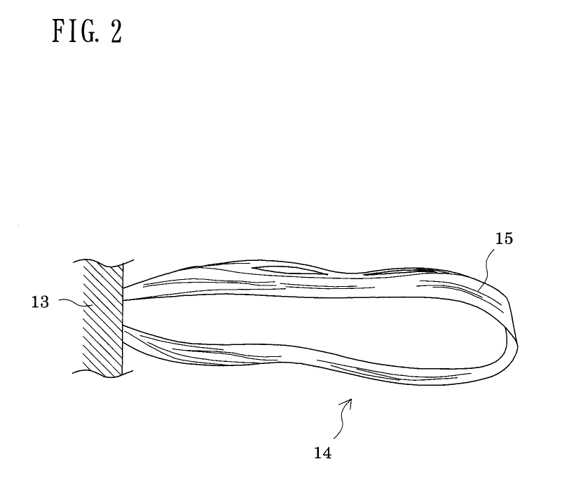

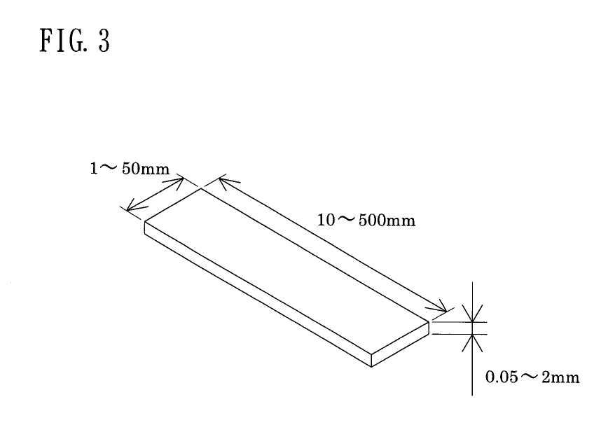

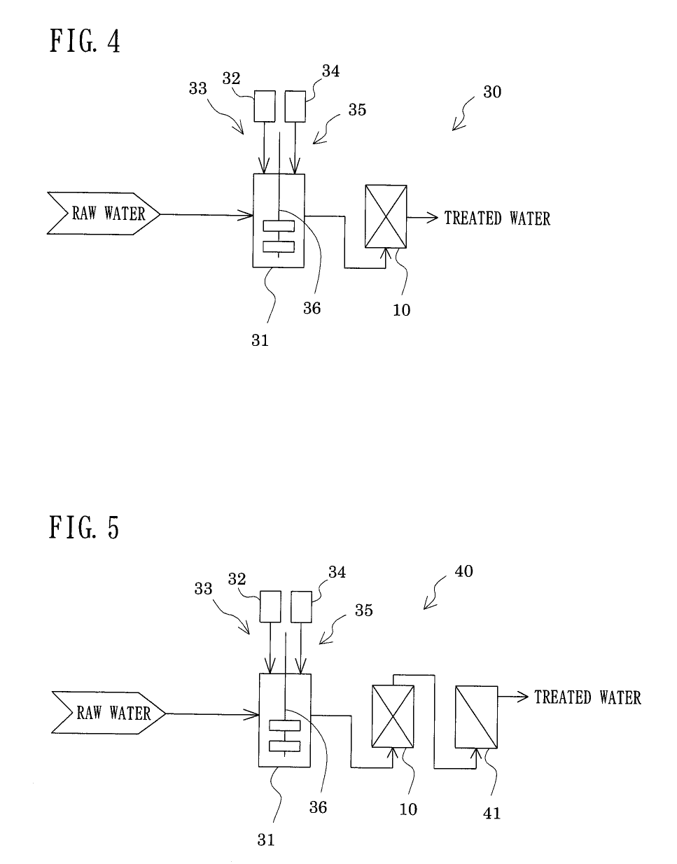

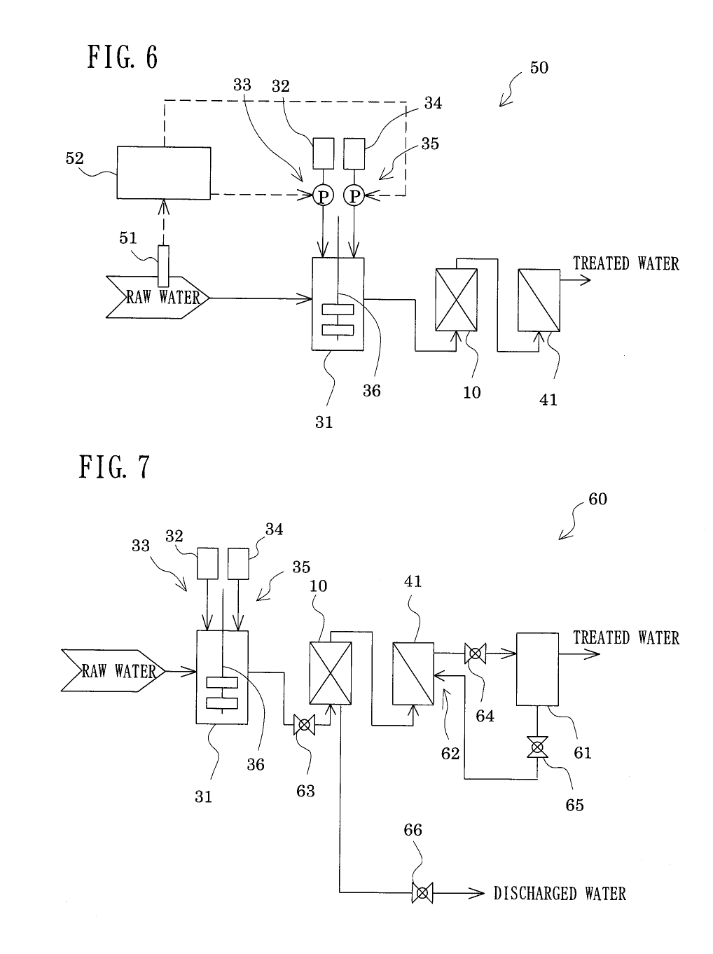

### BRIEF DESCRIPTION OF THE DRAWINGS

[FIG. 1] A cross-sectional view of a filtration apparatus according to Embodiment 1.

[FIG. 2] An enlarged view of an essential part of the filtration apparatus according to Embodiment 1.

[FIG. 3] A sketch of an exemplary suspended-solid-capturing member according to Embodiment 1.

[FIG. 4] A system diagram of an exemplary water treatment apparatus according to Embodiment 2.

[FIG. 5] A system diagram of an exemplary water treatment apparatus according to Embodiment 2.

[FIG. 6] A system diagram of an exemplary water treatment apparatus according to Embodiment 2.

[FIG. 7] A system diagram of an exemplary water treatment apparatus according to Embodiment 2.

### MODES FOR CARRYING OUT THE INVENTION

Embodiments of the present invention will next be described.

### Embodiment 1

FIG. 1 is a cross-sectional view of a filtration apparatus according to Embodiment 1, and FIG. 2 is an enlarged view of an essential part of FIG. 1.

As shown in FIG. 1, a filtration apparatus 10 has a tube-like filtration tank 11 to which treatment water 1 is fed, and a filtration member 12 for capturing solid suspended in the fed treatment water. The filtration member 12 is formed of a support member 13 which is connected to both ends of the filtration tank 11 in the water flow direction, and a ribbon-like suspended-solid-capturing member 14. At each end of the filtration tank 11 in the water flow direction, there is disposed a disk-shape plate 16 having a plurality of pores which allow suspended-solid-containing treatment water to freely pass therethrough and which are made of a material such as resin. Each end of the support member 13 is fixed at the center of the plate 16. The suspended-solid-capturing member 14 is fixed at the support member 13 through a part of the suspended-solid-capturing member being knitted into the support member. The free (unfixed) part; i.e., a loop portion, is disposed such that it protrudes outward from the support member toward the inner wall of the filtration tank 11. Thus, the filtration member 12 widely distributes in the filtration tank 11. Thus, the suspended-solid-capturing member 14 intersects the flow of water, whereby solid suspended in treatment water 1 is captured by the suspended-solid-capturing member 14. In Embodiment 1, the ribbon-like suspended-solid-capturing member 14 is produced by forming a long rectangular member (i.e., tape) into a loop shape. As shown in the enlarged view of the ribbon-like suspended-solid-capturing member 14 in FIG. 2, the member is provided with a plurality of slits 15, each slit not reaching a fixation end of the member. Through provision of the slits 15, suspended solid capturing performance is enhanced.

The filtration member 12 is charged in the filtration tank 11 such that a filtration portion of the filtration tank has a percent void of 50 to 95%, preferably 60 to 90% during passage of the treatment water. The percent void is calculated by the formula given below. The term “filtration portion” refers to an area where suspended solid present in the treatment water is captured by the filtration member 12; i.e., a space defined by the inner wall of the filtration tank 11 and both ends of the filtration member 12 in the water flow direction where the suspended-solid-capturing member 14 of the filtration member 12 is charged, from which space a portion not involving filtration (i.e., support member 13 in Embodiment 1) is removed. Notably, if there is no portion not involving filtration, the filtration portion means a space defined by the inner wall of the filtration tank 11 and both ends of the filtration member 12 in the water flow direction where the suspended-solid-capturing member 14 of the filtration member 12 is charged. In Embodiment 1, wherein a filtration portion is provided in a state where the filtration member 12 is not compacted and is charged in the filtration tank 11 during filtration operation (i.e., passage of treatment water), the difference “(volume of filtration portion)−(volume of suspended-solid-capturing member)” is readily obtained by calculation including subtracting the volume of the support member 13 from the volume of treatment water spilt from the filtration tank 11 when the filtration member 12 has been inserted in the filtration tank full of treatment water. In Embodiment 1, each end of the filtration member 12 is fixed to the corresponding end of the filtration tank 11 in the water flow direction, and the filtration member 12 is widely spread in the filtration tank 11 during passage of treatment water. Thus, the filtration portion corresponds to a portion defined by removing the support member 13 from the entire inner portion of the filtration tank 11.

Percent void(%)=[(volume of filtration portion)−(volume of suspended-solid-capturing member)/(volume of filtration portion)]×100 [F1]

When treatment water is caused to pass through the filtration apparatus 10, the treatment water passes through the space between pieces of the ribbon-like suspended-solid-capturing member 14 or and through the slits 15 provided in the suspended-solid-capturing member 14. During the passage, suspended solid contained in the treatment water is trapped by the ribbon-like suspended-solid-capturing member 14 and the slits 15, whereby the treatment water from which suspended solid has been removed is discharged from the filtration tank 11. Since the filtration member 12 is charged in the tank such that the filtration portion has a percent void of 50 to 95% during passage of water, passage of water is not obstructed, and suspended solid is effectively trapped. In the present invention, examples of the treatment water include industrial water, city water, well water, river water, lake water, industrial wastewater (in particular, industrial wastewater which has been subjected to biological treatment), and flocculation-treated (by adding a flocculant) water thereof.

As described above, when the filtration member 12 is charged in the tank such that the filtration portion has a percent void of 50 to 95% during passage of water, passage of water is not obstructed, and suspended solid is effectively trapped. Therefore, clogging of the filtration apparatus 10 can be suppressed, and clear treated water (e.g., water having a turbidity of 3 or less) can be obtained. When the percent void is in excess of 95%, the turbidity of the treated water increases excessively, although the filtration of water is accelerated and can be performed at high speed. When the percent void is lower than 50%, suspended solid is effectively trapped. However, water passage is not sufficient, and clogging occurs in the filtration apparatus and membrane separation means optionally disposed on the downstream side, whereby the differential pressure increase rate is excessively elevated. Particularly when filtration is carried out at such a high speed as 100 m/h or more, or when treatment water having a high turbidity (e.g., 20 or higher) is processed, in many cases, the obtained treated water has higher turbidity, and clogging occurs in the related apparatuses. In contrast, when the filtration apparatus 10 in which filtration member 12 is charged so as to attain a percent void of 50 to 95% is employed, clogging is suppressed, and clear treated water can be obtained, even in the case of high-speed filtration or high-turbidity treatment water. Needless to say, also in the case of low-speed filtration or treatment low-turbidity water, clogging is suppressed, and clear treated water can be obtained. The percent void is preferably uniform in the filtration portion. Therefore, the suspended-solid-capturing member 14 is preferably charged in the filtration tank 11 to a portion in the near vicinity of each end thereof in the water flow direction. Also, the suspended-solid-capturing member 14 is preferably charged in the filtration tank 11 to a portion virtually in the vicinity of the inner wall of the tank.

Variation in the volume of the filtration portion is not preferred. That is, the volume is preferably the same during passage of treatment water and during washing with a flow of liquid reverse to the passage of treatment water (hereinafter referred to as “reverse washing”), halt of filtration (as described hereinbelow), etc. Percent variation in volume of the filtration portion is 30% or less, preferably 10% or less. Through controlling the variation in volume, the dimensions of the filtration apparatus can be reduced.

In Example 1, no particular limitation is imposed on the dimensions of the filtration tank 11. In the case of a tubular tank, the diameter and the height may be 100 to 1,000 mm, and 200 to 1,000 mm, respectively. Notably, when the filtration tank 11 is larger than the filtration member 12, the percent void of the filtration portion is adjusted to 50 to 95% during water passage through, for example, charging a plurality of filtration members 12 in the filtration tank 11, or the size of the suspended-solid-capturing member 14 of the filtration member 12 is increased.

Examples of the material of the support member 13 or the suspended-solid-capturing member 14 include synthetic resins such as polypropylene, polyester, and nylon. The support member 13 may be produced by knitting synthetic fiber of a resin such as polypropylene, polyester, or nylon, to thereby enhance strength of the support member. Alternatively, the filtration member 12 may be formed into the shape of a twisted-wire brush. Specifically, the support member 13 made of a wire of anti-corrosive SUS or resin-coated metal is provided, and pieces of the suspended-solid-capturing member 14 are connected to the support member while being aligned. Then, the metal support member is twisted, to thereby form a radially spread filtration member. Thus, through enhancing the strength of the support member 13, bending of the support member 13 is prevented, and an end of the filtration member 12 is easily fixed, thereby facilitating replacement of the filtration member 12.

No particular limitation is imposed on the dimensions of the support member 13 or the suspended-solid-capturing member 14, so long as the percent void falls within the aforementioned ranges. For example, the thickness, width, and length (distance from the support member during passage of treatment water) of the suspended-solid-capturing member are about 0.05 to about 2 mm, about 1 to about 50 mm, and about 10 to about 500 mm, preferably about 0.3 to about 2 mm, about 1 to about 20 mm, and about 50 to about 200 mm.

In Embodiment 1, the filtration tank 11 of tubular shape is employed. However, no particular limitation is imposed on the shape of the filtration tank, and any hollow structure allowing water passage may be employed. For example, other than tube, a hollow prism may be selected. In Embodiment 1, each end of the support member 13 is fixed onto the plate 16. However, no particular limitation is imposed on the fixation manner, and it may be the case that only one end of the support member is fixed.

In Embodiment 1, the loop-like suspended-solid-capturing member 14 is disposed so as to be protruded from the support member 13. However, no particular limitation is imposed on the manner of disposition thereof. For example, as shown in FIG. 3, a plurality of strip-like suspended-solid-capturing members may be provided, and an end of each suspended-solid-capturing member may be fixed to the support member. In Embodiment 1, the suspended-solid-capturing member 14 has a rectangular cross-sectional shape. However, no particular limitation is imposed on the cross-sectional shape, and a circular cross-section may be employed. The suspended-solid-capturing members 14 may be of equal or different lengths. Further, in Embodiment 1, the suspended-solid-capturing member 14 has been made of a single material, but it may be made from two or more materials. The suspended-solid-capturing member may be provided with no, a single, or a plurality of slits. No support member 13 may be provided, and the filtration member 12 may be formed from only the suspended-solid-capturing member. However, since the filtration member 12 is preferably provided in virtually the entire space of the filtration tank 11, the suspended-solid-capturing member is preferably fixed at a certain position of the filtration tank.

### Embodiment 2

FIG. 4 is a system diagram of a water treatment apparatus according to Embodiment 2. The same elements as employed in Embodiment 1 are denoted by the same reference numerals, and overlapping descriptions have been omitted.

As shown in FIG. 4, a water treatment apparatus 30 includes a reaction tank 31 to which treatment water (raw water) is introduced; chemical-agent-introduction means 33 including, for example, a pump, the means being provided for introducing a chemical agent (e.g., particles of a cationic polymer which swells in water but does not substantially dissolve therein) from a chemical agent tank 32 to the reaction tank 31; inorganic flocculant-introduction means 35 including, for example, a pump, the means being provided for introducing an inorganic flocculant from an inorganic flocculant tank 34 to the reaction tank 31; and a filtration apparatus 10 as employed in Embodiment 1 to which treatment water which has been subjected to a flocculation treatment (e.g., adsorption or coagulation) in the reaction tank 31 is introduced.

In the water treatment apparatus 30, treatment water (raw water) is introduced to the reaction tank 31. Then, a chemical agent (e.g., particles of a cationic polymer which swells in water but does not substantially dissolve therein) stored in the chemical agent tank 32, or an inorganic flocculant stored in the inorganic flocculant tank 34 is added to the treatment water through introduction via the chemical-agent-introduction means 33 or the inorganic flocculant-introduction means 35 to the reaction tank 31. The treatment water to which the chemical agent (e.g., particles of a cationic polymer which swells in water but does not substantially dissolve therein) or an inorganic flocculant has been added is stirred by means of a stirrer 36, whereby flocculation treatment is performed. Subsequently, the treatment water which has been subjected to the flocculation treatment is discharged from the reaction tank 31 and fed to the filtration apparatus 10, where suspended solid is removed. Since the water treatment apparatus 30 of the present invention employs the filtration apparatus 10 filled with a filtration member such that the aforementioned percent void falls within a specific range, clogging of the filtration apparatus 10 is suppressed, and clear treated water can be obtained.

The treatment water contains, for example, a humic acid-containing organic substance, a fulvic acid-containing organic substance, a bio-metabolite such as sugar produced by algae, etc., or a synthetic chemical such as a surfactant. However, no particular limitation is imposed on the type of treatment water, and specific examples include industrial water, city water, well water, river water, lake water, and industrial wastewater (in particular, industrial wastewater which has been subjected to biological treatment). The term “humus” refers to a degraded substance which is formed through degradation of plant, etc. by the mediation of microorganisms. Humus contains humic acid and the like, and humus-containing water contains humus and/or soluble COD ingredients derived from humus, suspended substances, and coloring ingredients.

The cationic polymer which swells in water but does not substantially dissolve therein and which forms the particles of thereof which are added as a flocculant to the treatment water is a copolymer of a cationic monomer having a functional group such as a primary amine group, a secondary amine group, a tertiary amine group, a group of an acid-added salt thereof, or a quaternary ammonium group, and a cross-linking agent monomer for attaining substantially no water solubility. Specific examples of the cationic monomer include an acidic salt or quaternary ammonium salt of dimethylaminoethyl(meth)acrylate, an acidic salt or quaternary ammonium salt of dimethylaminopropyl(meth)acrylamide, and diallyldimethylammonium chloride. Examples of the cross-linking agent monomer include diviyl monomers such as methylenebis(acrylamide). Alternatively, a copolymer of the aforementioned cationic monomer and an anionic or nonionic monomer which can be co-polymerized therewith may also be employed. Specific examples of the anionic monomer to be co-polymerized include (meth)acrylic acid, 2-acrylamido-2-methylpropanesulfonic acid, and an alkali metal salt thereof. The amount of the anionic monomer must be small so that the formed copolymer maintains a cationic property. Examples of the nonionic monomer include (meth)acrylamide, N-isopropylacrylamide, N-methyl(N,N-dimethyl)acrylamide, acrylonitrile, styrene, and methyl or ethyl(meth)acrylates. These monomers may be used singly or in combination of two or more species. The amount of the cross-linking agent monomer such as a divinyl monomer is required to be 0.0001 to 0.1 mol % with respect to the total amount of the monomers. Through controlling the amount, the swellability and particle size (in water) of the particles of a cationic polymer which swells in water but does not substantially dissolve therein can be controlled. Examples of the commercial product of the particulate cationic polymer which swells in water but does not substantially dissolve therein include KURIVERTER EP (product of Kurita Water Industries Ltd.). Alternatively, an anion-exchange resin such as WA20 (product of Mitsubishi Chemical Co., Ltd.) may also be used as the particulate cationic polymer which swells in water but does not substantially dissolve therein. No particular limitation is imposed on the particle size of the particles of a cationic polymer which swells in water but does not substantially dissolve therein. However, the mean particle size in reverse-phase emulsion or dispersion (suspended); i.e., the mean particle size in a non-water-swelling state, is preferably 100 μm or less, more preferably, 0.1 to 10 μm.

No particular limitation is imposed on the method of adding to treatment water the aforementioned particulate cationic polymer which swells in water but does not substantially dissolve therein. For example, the particles as are, water dispersion thereof, or reverse-phase emulsion or dispersion (suspended) thereof may be added to treatment water. In any case, it is essential that the treatment water is subjected to flocculation treatment through addition of the particulate cationic polymer which swells in water but does not substantially dissolve therein to the treatment water; i.e., the treatment water comes into contact with the particles of a cationic polymer which swells in water but does not substantially dissolve therein, whereby the solid suspended in the treatment water is adsorbed by the particles.

Two or more particulate cationic polymers which swell but do not substantially dissolve in water may also be added to the treatment water. Notably, since the cationic polymer per se which forms the particles swells but does not substantially dissolve in water, particulates of the cationic polymer which swells in water but does not substantially dissolve therein swell but do not substantially dissolve in water, differing from a conventional polymer flocculant. The expression “not substantially dissolve in water” refers to such a water-solubility that the cationic polymer particles can be present in water. Specifically, the solubility of the particles in water at 30° C. is about 0.1 g/L or less. The amount of percent swelling of the particles in water is about 10 to about 200 times, as calculated by dividing particle size in water by particle size in a non-swelling state.

Next, a reverse-phase emulsion form of the particles of cationic polymer which swells in water but does not substantially dissolve therein will be described in detail. However, the particles are not limited to the form. The polymer particle emulsion is not a particular emulsion, but a conventional reverse-phase (W/O) polymer emulsion.

The reverse-phase emulsion contains the aforementioned cationic polymer which swells in water but does not substantially dissolve therein, water, a liquid hydrocarbon, and a surfactant. The compositional proportions (% by mass) are as follows: “cationic polymer which swells in water but does not substantially dissolve therein”:water:liquid hydrocarbon:surfactant=20 to 40:20 to 40:20 to 40:2 to 20. Preferably, the total amount of the cationic polymer which swells in water but does not substantially dissolve therein and water is adjusted to 40 to 60 mass % with respect to the total amount of the cationic polymer which swells in water but does not substantially dissolve therein, water, a liquid hydrocarbon, and a surfactant.

No particular limitation is imposed on the liquid hydrocarbon, and examples of the liquid hydrocarbon include aliphatic liquid hydrocarbons such as isoparaffine (e.g., isohexane), n-hexane, kerosine, and mineral oil.

Examples of the surfactant include C10 to C20 higher aliphatic alcohol polyoxyethylene ethers and C10 to C22 higher fatty acid polyoxyethylene esters, having an HLB (hydrophilic lipophilic balance) of 7 to 10. Examples of the ethers include alcohol (lauryl alcohol, cetyl alcohol, stearyl alcohol, oleyl alcohol, etc.) polyoxyethylene (EO addition mole:=3 to 10) ethers. Examples of the esters include fatty acid (lauric acid, palmitic acid, stearic acid, oleic acid, etc.) polyoxyethylene (EO addition=3 to 10) esters.

No particular limitation is imposed on the method of producing the reverse-phase emulsion. The emulsion may be produced through mixing a cationic monomer (for forming the cationic polymer which swells in water but does not substantially dissolve therein) and a cross-linking agent monomer with water, a liquid hydrocarbon, and a surfactant, and allowing the mixture to polymerize (via emulsion polymerization or suspension polymerization). In an alternative method, the monomers are solution-polymerized; the produced polymer is pulverized by means of a homogenizer or the like; and the polymer and a dispersant (e.g., surfactant) are added to a liquid hydrocarbon.

When the particulate cationic polymer which swells in water but does not substantially dissolve therein is added to treatment water, the particles preferably have a large surface area. Therefore, in a preferred manner, the particles in the form of reverse-phase emulsion or dispersion (suspended) are added to water under stirring, to thereby cause the particles to swell, and then the particles in the swelling state are added to the treatment water.

No particular limitation is imposed on the amount of the particulate cationic polymer which swells in water but does not substantially dissolve therein and which is added to treatment water. However, preferably, the amount is adjusted about 0.2 to about 5 mg/L with respect to the treatment water, and about 1 to about 50 mass % with respect to the solid suspended in the treatment water. No particular limitation is imposed on the pH of the treatment water to which the particulate cationic polymer which swells in water but does not substantially dissolve therein has been added. A lower pH, for example, about 5.0 to about 7.5, is preferred, since considerably excellent flocculation performance can be attained.

When the particulate cationic polymer which swells in water but does not substantially dissolve therein is added to the treatment water, a large mass of flocculate can be effectively formed in the treatment water, and clear treated water is readily obtained. However, clogging of a filtration apparatus and of a membrane separation apparatus optionally disposed on the downstream side of the filtration apparatus readily occurs, which is problematic. According to the present invention, since the filtration apparatus 10 filled with a filtration member such that the aforementioned percent void falls within a specific range is employed, clogging of the filtration apparatus 10, which would otherwise be caused by the particles of a cationic polymer which swells in water but does not substantially dissolve therein, is favorably suppressed, and clear treated water can be continuously obtained.

No particular limitation is imposed on the inorganic flocculant added to treatment water, and examples of the inorganic flocculant include aluminum salts such as aluminum sulfate and polyaluminum chloride; and iron salts such as ferric chloride and ferrous sulfate. No particular limitation is imposed on the amount of inorganic flocculant added to treatment water, which may be adjusted in accordance with the quality of the treatment water. The amount is about 0.5 to about 10 mg/L as reduced to aluminum or iron with respect to the amount of treatment water. When polyaluminum chloride (PAC) is used as an inorganic flocculant, and the pH of the treatment water to which a particulate cationic polymer which swells in water but does not substantially dissolve therein and an inorganic flocculant have been added is adjusted to about 5.0 to about 7.0, flocculation is most favorably occurs, although the flocculation performance depends on the quality of the treatment water. The inorganic flocculant may be added to the treatment water before or after the addition of the particulate cationic polymer which swells in water but does not substantially dissolve therein. Alternatively, the inorganic flocculant may be added to the treatment water simultaneously with the particulate cationic polymer which swells in water but does not substantially dissolve therein.

As shown in FIG. 5, the membrane separation means 41 may be disposed on the downstream side of the filtration apparatus 10 of the water treatment apparatus 30, to thereby construct a water treatment apparatus 40. Examples of the membrane employed in the membrane separation include micro-filtration membrane (MF membrane), ultra-filtration membrane (UF membrane), nano-filtration membrane (NF membrane), and reverse osmosis membrane (RO membrane). A single type of these membranes may be used singly in a plurality of stages. Alternatively, a plurality of types of membranes may be combined. In one embodiment, treatment water is subjected to membrane separation by means of an MF membrane or UF membrane, and the thus-treated water is further subjected to membrane separation by means of an RO membrane.

Generally, the treatment water (e.g., industrial water, city water, well water, or biologically treated water) contains a membrane-fouling substance such as a humic acid-containing organic substance, a fulvic acid-containing organic substance, a bio-metabolite such as sugar produced by algae, etc., or a synthetic chemical such as a surfactant. Therefore, when such treatment water is subjected to membrane separation, membrane-fouling substances are adsorbed on the surface of the employed membrane, leading to problematic deterioration in membrane separation performance. However, in Embodiment 2, since the particles of a cationic polymer which swells in water but does not substantially dissolve therein are added to treatment water before membrane separation, membrane-fouling substances are adsorbed by the particles to thereby form flocculates, and membrane separation is performed after flocculation. Therefore, treatment water containing a low-level dissolved organic substance such as a bio-metabolite serving as a membrane-fouling substance can be subjected to membrane separation, whereby adsorption of membrane-fouling substances onto the membrane is mitigated, and deterioration in membrane separation performance is suppressed. Notably, as shown in FIG. 5, the filtration apparatus 10 and the membrane separation means 41 are installed in line at different sites. However, no particular limitation is imposed on the installation mode, and the filtration apparatus 10 and the membrane separation means 41 may be installed vertically to form a single combined unit. This mode is advantageous, since the area of the installation site and the number of the parts employed in the installation can be decreased.

As shown in FIG. 6, a water treatment apparatus 50 may be provided with other members in addition to the water treatment apparatus 30 or the water treatment apparatus 40. Specifically, absorbance-measuring means 51 for measuring absorbance may be added to a raw water tank for reserving treatment water (raw water), and an amount control means 52 may be provided. The amount control means 52 receives absorbance data obtained by the absorbance-measuring means 51, and calculates the amount of the particulate cationic polymer which swells in water but does not substantially dissolve therein and which is fed from the chemical agent tank 32 to the reaction tank 31, and the amount of the inorganic flocculant fed from the inorganic flocculant tank 34 to the reaction tank 31, to thereby control the amounts of the additives.

The amount control means 52 has calibration information for controlling the amount of an additive. Specifically, each of the water samples having various absorbance values is treated in a jar tester by use of a particulate cationic polymer which swells in water but does not substantially dissolve therein and an inorganic flocculant. The relationship between the absorbance of the treatment water and the optimum amount of the particulate cationic polymer which swells in water but does not substantially dissolve therein is obtained. The thus-obtained relationship is stored as calibration information for controlling the amount of the particles. The amount control means 52 calculates the optimum amount of the particles added to treatment water from the absorbance data of treatment water (raw water) measured by the absorbance-measuring means 51 and the relationship (calibration information), whereby the amount of the particulate cationic polymer which swells in water but does not substantially dissolve therein and which is fed from the chemical-agent-introduction means 33 is controlled. Similarly, the amount control means 52 has calibration information for controlling the amount of another additive. Specifically, each of the water samples having various absorbance values is treated by use of an inorganic flocculant. The relationship between the absorbance of the treatment water and the optimum amount of the inorganic flocculant is obtained. The thus-obtained relationship is stored as calibration information for controlling the amount of the inorganic flocculant. The amount control means 52 calculates the optimum amount of the inorganic flocculant added to treatment water from the absorbance data of treatment water (raw water) measured by the absorbance-measuring means 51 and the relationship (calibration information), whereby the amount of the inorganic flocculant fed from the inorganic flocculant-introduction means 17 is controlled.

Taking as an example the particulate cationic polymer which swells in water but does not substantially dissolve therein, the mode of controlling the additive amount will be described in detail. Firstly, the relationship between the absorbance data of treatment water samples and the amount of the particulate cationic polymer which swells in water but does not substantially dissolve therein, which amount is suitable for treating the treatment water having a specific absorbance (i.e., the amount of the particles which is sufficient for coagulating a soluble organic substance serving as suspended solid and which is not excessive), is derived as calibration information for controlling the additive amount. Before water treatment, the absorbance of the treatment water is measured. On the basis of the measured absorbance and the calibration information for controlling the additive amount, the amount of the particulate cationic polymer which swells in water but does not substantially dissolve therein is controlled.

The absorbance values of treatment water measured at at least one wavelength falling within a UV region of 200 to 400 nm and at at least one wavelength falling within a visible-light region of 500 to 700 nm have the following correlation with the soluble organic substance concentration.

Soluble organic substance concentration=A×[(absorbance in UV region)−(absorbance in visible-light region)]

In addition, there is a certain correlation between the soluble organic substance concentration and the optimum amount of the particles of added to treatment water, which amount is obtained from the time required for filtering a predetermined amount of water by means of a 0.45-μm membrane filter (hereinafter referred as a KMF value). Thus, through measuring the absorbance at at least one wavelength in an UV-region and at at least one wavelength in a visible-light region, the optimum amount of the particulate cationic polymer which swells in water but does not substantially dissolve therein and which is added to water can be estimated.

Specifically, water samples having different qualities (e.g., industrial water samples sampled on different days) are subjected to a jar test in advance. From the differences between absorbance in UV region and absorbance in visible-light region, and the optimum concentration values of the particulate cationic polymer which swells in water but does not substantially dissolve therein, the relationship (information for controlling the amount of added polymer particles) represented by the below-described formula (I) is derived. In formula (I), each of A to C represents a constant depending on a quality of treatment water such as soluble organic compound concentration. E260 represents an absorbance measured at 260 nm, and E660 represents an absorbance measured at 660 nm. In water treatment, the absorbance of the treatment water is measured, and the optimum concentration of the polymer particles is determined from the absorbance data and the relationship represented by formula (I). The particles in the thus-determined optimum amount are added to the treatment water.

(Concentration of the particulate cationic polymer which swells in water but does not substantially dissolve therein)

=A×(E260−E660)³+C (I)

In the aforementioned procedure, the relationship (information for controlling the amount of added polymer particles) between the difference between absorbance in UV region and absorbance in visible-light region, and the optimum concentration value of the particulate cationic polymer which swells in water but does not substantially dissolve therein is derived. However, determination of the amount of added polymer particles is not limited to the aforementioned manner, and, for example, a threshold control method may also be employed. No particular limitation is imposed on the threshold control method. In one embodiment, when the absorbance difference is less than a specific value a₁, the concentration of added particulate cationic polymer which swells in water but does not substantially dissolve therein is adjusted to b₁; when the absorbance difference is a specific value of a₁ to a₂, the concentration of added polymer particles is adjusted to b₂; and when the absorbance difference is in excess of a specific value of a₂, the concentration of added polymer particles is adjusted to b₂.

Thus, through controlling the amount of the particulate cationic polymer which swells in water but does not substantially dissolve therein and which is added to treatment water on the basis of the amount of soluble organic substance forming suspended solid in the treatment water, an optimum amount of the particulate cationic polymer which swells in water but does not substantially dissolve therein and which can be added to the treatment water, to thereby enhance treatment water efficiency. In addition, even when the quality of treatment water varies, the amount of the particulate cationic polymer which swells in water but does not substantially dissolve therein and which is added to the treatment water can be optimized in accordance with the varied quality, whereby very clear treated water can be consistently obtained. Notably, the amount of inorganic flocculant may also be controlled in a manner similar to the case of controlling of the amount of the particulate cationic polymer which swells in water but does not substantially dissolve therein.

Since the turbidity of treatment water and the soluble organic substance concentration have a correlation, turbidity may be measured instead of absorbance. Through controlling the turbidity in a manner similar to the control of absorbance, an optimum amount of the particulate cationic polymer which swells in water but does not substantially dissolve therein or an optimum amount of the inorganic flocculant can be added to the treatment water, to thereby enhance treatment water efficiency. In addition, even when the quality of treatment water varies, the amount of the particulate cationic polymer which swells in water but does not substantially dissolve therein or the amount of the inorganic flocculant added to the treatment water can be optimized in accordance with the varied quality, whereby vary clear treated water can be consistently obtained. Needless to say, both control of the flocculant amount on the basis of the absorbance data of treatment water (raw water), and control of the flocculant amount on the basis of the turbidity data of treatment water may be performed.

As shown in FIG. 7, another water treatment apparatus having washing-liquid-introduction means for introducing washing liquid and air to the filtration apparatus 10 in a reverse direction of water passage may be provided with other members in addition to the water treatment apparatus 30 or the water treatment apparatus 40. Specifically, for example, as shown in FIG. 7, the water treatment apparatus has a treated water tank 61 for reserving the water treated by membrane separation means 41, and washing-liquid-introduction means 62 for introducing treated water (serving as a washing liquid) and air reserved in the treated water tank 61 sequentially to the membrane separation means 41 and the filtration apparatus 10.

In the water treatment apparatus 60, the water which has been filtered is subjected to membrane separation, and the thus-treated water is reserved in the treated water tank 61. In the course of passage of treatment water, membrane-fouling substances; i.e., solid matter and other suspended solid originating from the particles of a cationic polymer which swells in water but does not substantially dissolve therein (flocculant) and the inorganic flocculant added to the treatment water, are gradually deposited on the filtration member 12 of the filtration apparatus 10, whereby the performance of the filtration member is impaired. Similarly, membrane-fouling substances; i.e., solid matter and other suspended solid originating from the particles of a cationic polymer which swells in water but does not substantially dissolve therein (flocculant) and the inorganic flocculant added to the treatment water, are gradually deposited on the MF membrane etc. of the membrane separation means 41, whereby the membrane separation performance is impaired. Thus, a valve 63 disposed between the reaction tank 31 and the filtration apparatus 10, and a valve 64 disposed between the membrane separation means 41 and the treated water tank 61 and being opened during membrane separation are closed at an arbitrary frequency, to thereby interrupt membrane separation. Then, a valve 65 connecting the treated water tank 61 and the membrane separation means 41 is opened, whereby an air-water mixture reserved in the treated water tank 61 is introduced to the membrane separation means 41 via the washing-liquid-introduction means 62 such as a pump. For example, through passage of the washing liquid for about one minute in the reverse direction, the separation membrane is subjected to reverse washing. Subsequently, when the washing liquid which has passed through the membrane separation means 41 is caused to pass through the filtration apparatus 10, the filtration member 12 is washed by the washing liquid. The washing liquid is discharged from the filtration apparatus 10 via a valve 66 to the outside of the water treatment apparatus 60. Notably, even when no pump or a similar means for feeding the washing liquid is disposed between the membrane separation means 41 and the filtration apparatus 10, the washing liquid can be introduced to the filtration apparatus 10 by the mediation of the washing-liquid-introduction means 62 for introducing washing liquid to the membrane separation means 41.

After washing of the membrane separation means 41 and the filtration apparatus 10 by the washing liquid and air, the valves 63, 64 are opened, and the valves 65, 66 are closed, whereby filtration and membrane separation are started again. Thus, through washing the filtration apparatus 10 and the membrane separation means 41, suspended solid adsorbed by the filtration member 12 and the separation membrane can be removed. Therefore, deterioration in filtration performance and membrane separation performance can be reliably prevented. In an alternative manner, treated water and air may be introduced only to the filtration apparatus 10.

In the case where the filtration member 12 can move in the filtration tank 11 (e.g., the case where ends of the filtration member 12 are not fixed), the volume of the filtration portion during filtration and that during reverse washing may be different. The percent change in volume between filtration and washing is preferably 30% or less, particularly preferably 10% or less. Through such control of the volume change, the water treatment apparatus can be small-sized, and the turbidity of the treated water can be reliably reduced.

In Embodiment 2, a particulate cationic polymer which swells in water but does not substantially dissolve therein and an inorganic flocculant are both used as a flocculant, but either one of them may be used. Alternatively, a polymer flocculant or the like may be used singly or in combination with the aforementioned flocculants. Examples of the polymer flocculant include anionic organic polymer flocculants such as poly(meth)acrylic acid, (meth)acrylic acid-(meth)acrylamide copolymer, alkali metal salts thereof; nonionic organic polymer flocculants such as poly(meth)acrylamide; and cationic organic polymer flocculants such homopolymers of a cationic monomer (e.g., dimethylaminoethyl(meth)acrylate or a quaternary ammonium salt thereof, or dimethylaminopropyl(meth)acrylamide or a quaternary ammonium salt thereof), and copolymers of the cationic monomer and an nonionic monomer which can be co-polymerized therewith. No particular limitation is imposed on the amount of organic polymer flocculant added to treatment water, and the amount may be adjusted in accordance with the quality of the treatment water. Generally, the amount is about 0.01 to about 10 mg/L (solid content/water). In Embodiment 2, flocculants are introduced to the reaction tank 31, but the flocculant(s) may be introduced on the upstream side of the reaction tank 31.

The water treatment apparatus of the invention may further include water purification means such as decarbonation means or activated-carbon-treatment means. If required, the water treatment apparatus of the invention may optionally include UV-radiation means, ozonization means, biological-treatment means, etc.

If required, additives such as a coagulant, a sterilizer, a deodorant, a defoaming agent, and an anti-corrosive may be used. These additives are introduced to, for example, the chemical agent tank 32.

### EXAMPLES

The present invention will next be described in more detail by way of Examples and Comparative Examples, which should not be construed as limiting the invention thereto.

### Relationship Between Percent Void and Differential Pressure Increase or Turbidity of Treated Water)

Industrial water having a turbidity of 20° was employed as treatment water (raw water) and treated by means of an apparatus shown in FIG. 4 at an LV of 200 m/h for one week. As shown in FIG. 1, the filtration member employed in the filtration apparatus is composed of a support member 13 and a ribbon-like suspended-solid-capturing member 14, and both ends of the support member in a direction of water passage are fixed onto corresponding plates 16 of a filtration tank 11. The support member 13 has a capacity of 250 mL, each piece of the suspended-solid-capturing member 14 has a thickness of 0.5 mm, a width of 2 mm, and a length (distance from the support member during passage of treatment water) of 100 mm, and is knitted into the support member so as to assume the loop shape. Through varying the knitting density of the suspended-solid-capturing member 14, filtration members having different percent void values of a filtration portion (defined by subtracting the volume of support member 13 from the inner volume of the filtration tank 11) during water passage of 30, 40, 50, 60, 70, 80, 90, 95, and 98% were fabricated. Each filtration member was subjected to water treatment. Notably, since the support member was fixed at both ends, the volume of the filtration member during passage of treatment water and that in another stage were substantially the same (percent volume change of substantially 0). The filtration tank 11 has a diameter of 200 mm and a height of 500 mm. To treatment water, added were 30 mg/L of polyaluminum chloride (PAC: 10 wt. % as Al₂O₃) serving as a flocculant and 0.7 mg/L of KURIVERTER EP (product of Kurita Water Industries Ltd., CE (colloid equivalent): 1.3 meq/g (as polymer particles)) serving as polymer particles. The turbidity of the treated water discharged from the filtration apparatus (treated water turbidity) and the increase in differential pressure of the filtration apparatus (differential pressure increase rate) were measured. The results are shown in Table 1. The turbidity of treated water was determined through measurement of transmitted light with respect to a kaolin standard solution. The differential pressure increase rate of the filtration apparatus was determined on the basis of the difference between the inlet pressure and the outlet pressure.

As a result, when a filtration apparatus in which a filtration member is charged such that a filtration portion has a percent void of 50 to 95% during passage of water was employed, the differential pressure increase rate and the treated water turbidity were considerably low, clear treated water was obtained, and clogging was suppressed, as compared with the cases where the percent void fell outside the range of 50 to 95%.

TABLE 1

| | Filtration member composed of | |
|---|---|---|
| | support member and ribbon- | |
| | like suspended-solid-capturing | |
| | member | |
| | Differential | Treated |
| | pressure | water |
| Percent | increase rate | turbidity |
| void % | (kPa/D) | (°) |
| 98 | 0 | 14 |
| 95 | 0 | 3.7 |
| 90 | 0 | 3.1 |
| 80 | 0 | 2.3 |
| 70 | 0 | 1.3 |
| 60 | 0.2 | 1.3 |
| 50 | 2 | 0.9 |
| 40 | 21 | 0.6 |
| 30 | 56 | 0.3 |

### Example 1

Industrial water having a turbidity of 3.4 to 22°, a TOC (total organic carbon) of 0.3 to 4.8 mg/L, and a temperature of 24.5 to 26.0° C. was employed as treatment water (raw water) and treated by means of an apparatus (feed of raw water: 50 L/h) shown in FIG. 5 at an LV of 200 m/h, while the quality of the treatment water was periodically varied. An MF membrane was employed as a separation membrane of the membrane separation means 41. The turbidity of the treated water discharged from the filtration apparatus and the differential pressure increase rate of the filtration apparatus were measured, and the results are shown in Table 2. As shown in FIG. 1, the filtration apparatus 10 includes a filtration member composed of a support member and a ribbon-like suspended-solid-capturing member. Each piece of the suspended-solid-capturing member 14 has a thickness of 0.5 mm, a width of 2 mm, and a length of 100 mm. The percent void of a filtration portion (defined by subtracting the volume of support member 13 from the inner volume of the filtration tank 11) during water passage was 85%. The support member 13 of the filtration member 12 was fixed at only one end thereof onto the plate 16 disposed on the upstream side in the direction of water passage. Although the other end of the support member 13 remained unfixed, the filtration member was distributed uniformly and generally in the entire portion of the filtration tank during passage of treatment water, since one end of the support member was fixed on the plate 16 on the upstream side. Polyaluminum chloride (PAC: 10 wt. % as Al₂O₃) serving as a flocculant was added in an amount of 30 mg/L with respect to the treatment water.

### Example 2

The procedure of Example 1 was repeated, except that 2 to 5 slits were provided in a portion of each piece of the loop-like suspended-solid-capturing member other than the support member-bound portion.

### Example 3

The procedure of Example 2 was repeated, except that the ends of the support member 13 of the filtration member 12 were fixed to the plates 16 on the upstream side and the downstream side in the direction of water passage, respectively.

### Example 4

The procedure of Example 3 was repeated, except that KURIVERTER EP was added instead of PAC to treatment water in an amount of 1.4 mg/L.

### Example 5

The procedure of Example 3 was repeated, except that KURIVERTER EP was also added to treatment water in an amount of 0.7 mg/L.

### Example 6

The procedure of Example 5 was repeated, except that the absorbance of raw water was measured, and the concentrations of PAC and KURIVERTER EP added to the raw water were controlled on the basis of the obtained absorbance data.

### Example 7

The procedure of Example 5 was repeated, except that the turbidity of raw water was measured, and the concentrations of PAC and KURIVERTER EP added to the raw water were controlled on the basis of the obtained absorbance data.

### Example 8

The procedure of Example 5 was repeated, except that the absorbance and turbidity of raw water were measured, and the concentrations of PAC and KURIVERTER EP added to the raw water were controlled on the basis of the obtained absorbance and turbidity data.

### Comparative Example 1

The procedure of Example 8 was repeated, except that a sand filtration apparatus was employed instead of the filtration apparatus.

TABLE 2

| | | Differential |
|---|---|---|
| | Treated water | pressure |
| | turbidity | increase rate |
| | (°) | (kPa/D) |
| Ex. 1 | 2.4 to 2.9 | 0.75 |
| Ex. 2 | 2.1 to 2.3 | 0.61 |
| Ex. 3 | 2.0 to 2.2 | 0.6 |
| Ex. 4 | 0.4 to 1.0 | 0.23 |
| Ex. 5 | 0.4 to 0.9 | 0.28 |
| Ex. 6 | 0.4 to 0.7 | 0.16 |
| Ex. 7 | 0.3 to 0.8 | 0.19 |
| Ex. 8 | 0.3 to 0.5 | 0.15 |
| Comp. Ex. 1 | 0.8 to 3.8 | 1.6 |

As shown in Table 2, in Examples 1 to 8, the turbidity of treated water and the differential pressure increase rate were found to be low, and clear treated water was obtained. No clogging occurred in the filtration apparatus. The feature of the results of each Example will be described. In Example 1, as compared with Comparative Example 1, the treated water turbidity was almost equivalent, and differential pressure increase was slow. In Example 2 employing a filtration member having slits, as compared with Example 1, the treated water turbidity decreased, and differential pressure increase was slow. In Example 3 employing a filtration member whose ends were fixed to the filtration tank, as compared with Example 2, the turbidity of treated water decreased when high-turbidity water was treated. In Example 4 employing as a flocculant a particulate cationic polymer which swells in water but does not substantially dissolve therein, coarse flocculates were formed, and the treated water turbidity decreased, and differential pressure increase was slow, as compared with Example 3. In Example 5 employing as flocculants PAC and a particulate cationic polymer which swells in water but does not substantially dissolve therein, the treated water turbidity decreased, and differential pressure increase was slow, as compared with Example 3. In Example 6 employing control of the amount of flocculant added to water on the basis of absorbance data, and in Example 7 employing control of the amount of flocculant added to water on the basis of turbidity data, the treated water turbidity decreased, and differential pressure increase was slow, as compared with Example 5. In Example 8 employing control of the amount of flocculant added to water on the basis of absorbance data and turbidity data, the treated water turbidity decreased, and differential pressure increase was slow, as compared with Examples 6 and 7.

### Example 9

The procedure of Example 1 was repeated, except that industrial water having a turbidity of 3.2 to 29°, a TOC (total organic carbon) of 0.4 to 5 mg/L, and a temperature of 24.5 to 26.1° C. was employed as treatment water (raw water), and that a step of reverse washing of the membrane separation means and the filtration apparatus by use of treated water which had been discharged from the membrane separation means having an MF membrane was performed. The turbidity of the treated water discharged from the filtration apparatus, and the differential pressure increase rate of the MF membrane were determined. The turbidity of the treated water was determined through measurement of transmitted light with respect to a kaolin standard solution. The differential pressure increase rate of the MF membrane was determined on the basis of the difference between the inlet pressure and the outlet pressure. Table 3 shows the results.

### Example 10

The procedure of Example 9 was repeated, except that air was introduced to the treated water discharged from the membrane separation means having an MF membrane.

### Example 11

The procedure of Example 10 was repeated, except that 2 to 5 slits were provided in a portion of each piece of the loop-like suspended-solid-capturing member other than the support member-bound portion.

### Example 12

The procedure of Example 10 was repeated, except that the ends of the support member 13 of the filtration member 12 were fixed to the plates 16 on the upstream side and the downstream side in the direction of water passage, respectively. Notably, since the support member 13 was fixed by the plates 16 at respective ends, the volume of the filtration member during passage of treatment water and that in another stage (e.g., reverse washing) were substantially the same (percent volume change of substantially 0).

### Example 13

The procedure of Example 10 was repeated, except that KURIVERTER EP was added instead of PAC to treatment water in an amount of 1.4 mg/L.

### Example 14

The procedure of Example 10 was repeated, except that KURIVERTER EP was also added to treatment water in an amount of 0.7 mg/L.

### Example 15

The procedure of Example 14 was repeated, except that the absorbance of raw water was measured, and the concentrations of PAC and KURIVERTER EP added to the raw water were controlled on the basis of the obtained absorbance data.

### Example 16

The procedure of Example 14 was repeated, except that the turbidity of raw water was measured, and the concentrations of PAC and KURIVERTER EP added to the raw water were controlled on the basis of the obtained turbidity data.

### Example 17

The procedure of Example 14 was repeated, except that the absorbance and turbidity of raw water were measured, and the concentrations of PAC and KURIVERTER EP added to the raw water were controlled on the basis of the obtained absorbance and turbidity data.

### Example 18

The procedure of Example 17 was repeated, except that the water treatment apparatus included an RO membrane apparatus disposed on the downstream side of the membrane separation means having an MF membrane. The TOC level of the water which had passed through the RO membrane was determined through a wet oxidation-IR absorption method. Table 4 shows the results.

### Example 19

The procedure of Example 18 was repeated, except that the water treatment apparatus included a recyclable ion-exchange resin apparatus instead of the RO membrane apparatus, and that the TOC level of the water which had passed through the recyclable ion-exchange resin apparatus was determined through a wet oxidation-IR absorption method.

### Comparative Example 2

The procedure of Example 18 was repeated, except that no filtration apparatus was employed.

TABLE 3

| | | Differential |
|---|---|---|
| | Treated water | pressure |
| | turbidity | increase rate |
| | (°) | (kPa/D) |
| Ex. 9 | 2.4 to 2.9 | 0.74 |
| Ex. 10 | 2.3 to 2.8 | 0.67 |
| Ex. 11 | 1.2 to 1.9 | 0.42 |
| Ex. 12 | 1.1 to 1.7 | 0.37 |
| Ex. 13 | 0.5 to 1.4 | 0.41 |
| Ex. 14 | 0.4 to 1.1 | 0.35 |
| Ex. 15 | 0.4 to 0.9 | 0.28 |
| Ex. 16 | 0.4 to 1.0 | 0.21 |
| Ex. 17 | 0.3 to 0.7 | 0.18 |
| Comp. Ex. 2 | — | 2.1 |

TABLE 4

| | TOC level |
|---|---|
| | (ppb) |
| Ex. 18 | 21 |
| Ex. 19 | 48 |

As shown in Tables 3 and 4, in Examples 9 to 19, the turbidity or TOC level of treated water and the differential pressure increase rate (MF membrane) were found to be low, and clear treated water was obtained. No clogging occurred in the MF membrane, and no clogging occurred in the filtration apparatus. The feature of the results of each Example will be described. In Example 9, the treated water turbidity was low, and differential pressure increase was slow as compared with Comparative Example 2. In Example 10 including reverse washing with a water-air mixture, differential pressure increase was slow as compared with Example 9. In Example 11 employing a filtration member having slits, as compared with Example 10, the treated water turbidity decreased, and differential pressure increase was slow. In Example 12 employing a filtration member whose ends were fixed to the filtration tank, as compared with Example 10, the turbidity of treated water decreased when high-turbidity water was treated. In Example 13 employing as a flocculant a particulate cationic polymer which swells in water but does not substantially dissolve therein, coarse flocculates were formed, and the treated water turbidity decreased, and differential pressure increase was slow, as compared with Example 10. In Example 14 employing as flocculants PAC and a particulate cationic polymer which swells in water but does not substantially dissolve therein, the treated water turbidity decreased, and differential pressure increase was slow, as compared with Example 13. In Example 15 employing control of the amount of flocculant added to water on the basis of absorbance data, and in Example 16 employing control of the amount of flocculant added to water on the basis of turbidity data, the treated water turbidity decreased, and differential pressure increase was slow, as compared with Example 14. In Example 17 employing control of the amount of flocculant added to water on the basis of absorbance data and turbidity data, the treated water turbidity decreased, and differential pressure increase was slow, as compared with Examples 15 and 16. In Example 18, the TOC level of the water which had passed through the RO membrane was low as compared with Example 19.

### DESCRIPTION OF THE REFERENCE NUMERALS

10, 20 filtration apparatus, 11 filtration tank, 12 filtration member, 13 support member, 14 suspended-solid-capturing member, 15 slit, 16 plate, 24 filler, 30, 40, 50, 60 water treatment apparatus, 31 reaction tank, 32 chemical agent tank, 33 chemical-agent-introduction means, 34 inorganic flocculant tank, 35 inorganic flocculant-introduction means, 41 membrane separation means, 51 absorbance-measuring means, 52 addition amount control means, 61 treated water tank, 62 washing-liquid-introduction means, 63 to 66 valve

1. A filtration apparatus, characterized by comprising a filtration member which has a ribbon-like suspended-solid-capturing member for capturing suspended solid present in fed treatment water, wherein the filtration member is charged in a filtration tank such that a filtration portion of the filtration tank has a percent void of 50 to 95% during passage of the treatment water, and percent variation in volume of the filtration portion is 10% or less.

2. A filtration apparatus according to claim 1, wherein the filtration member has a support member which is connected to both ends of the filtration tank along the water flow direction, and the ribbon-like suspended-solid-capturing member is provided such that the member is fixed at a part thereof to the support member and protrudes from the support member toward the inner wall of the filtration tank.

3. A filtration apparatus according to claim 1, wherein the ribbon-like suspended-solid-capturing member is provided with one or more slits.

4. A water treatment apparatus, characterized by comprising:
a reaction tank to which treatment water is introduced;
flocculant-introduction means for adding a flocculant to the treatment water at the reaction tank or on the upstream side of the reaction tank; and
a filtration apparatus as recited in claim 1 to which the treatment water which has been subjected to flocculation treatment in the reaction tank is introduced, the filtration apparatus being disposed on the downstream side of the reaction tank.

5. A water treatment apparatus according to claim 4, which further includes membrane separation means for treatment water, the means being disposed on the downstream side of the filtration apparatus.

6. A water treatment apparatus according to claim 4, wherein the flocculant is at least one species selected from an inorganic flocculant and a particulate cationic polymer which swells in water but does not substantially dissolve therein.

7. A water treatment apparatus according to claim 4, which further includes absorbance-measuring means for measuring the absorbance of treatment water, the means being disposed on the upstream side of the flocculant-introduction means, and first flocculant amount control means for controlling the amount of the flocculant added to treatment water on the basis of the absorbance measured by means of the absorbance-measuring means.

8. A water treatment apparatus according to claim 7, wherein the absorbance is preferably measured at at least one wavelength falling within a UV region of 200 to 400 nm and at at least one wavelength falling within a visible-light region of 500 to 700 nm.

9. A water treatment apparatus according to claim 4, which further includes turbidity-measuring means for measuring the turbidity of treatment water, the means being disposed on the upstream side of the flocculant-introduction means, and second flocculant amount control means for controlling the amount of the flocculant added to treatment water on the basis of the turbidity measured by means of the turbidity-measuring means.

10. A water treatment apparatus according to claim 4, which further includes washing liquid introduction means for introducing a washing liquid and air into the filtration apparatus at an arbitrary frequency.
